(19) United States
(12) Patent Application Publication
(10) Pub. No.: US 2007/0086771 A1
(43) Pub. Date: Apr. 19, 2007

(54) Photo module capable of adjusting distance between camera module and sensor unit

(75) Inventors: Yi-Ming Lee, Taipei City (TW); Yung-Chuan Chen, Taipei City (TW); Yen-Kuang Chen, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/580,830

(22) Filed: Oct. 16, 2006

(30) Foreign Application Priority Data
Oct. 17, 2005 (TW) 094136146

(51) Int. Cl. G02B 7/04

(52) U.S. Cl. 396/144

(57) ABSTRACT

A photo module includes a sensor unit for detecting and transforming a light beam into an image; a lens module includes a lens set for receiving and focusing the light beam; and a focus-adjusting module, coupled to the lens set, for controlling the lens set to move without rotation to adjust the relative distance between the lens set and the sensor unit, thereby forcing the lens module to focus the light beam on the sensor unit.

### BACKGROUND OF THE INVENTION

1. Field of the Invention

The present invention provides a photo module capable of adjusting focus position of a light beam, and in particular, a photo module whose focus-adjusting module and lens module are positioned separately such that when the focus-adjusting module drives the lens module to move, the reduced friction will not cause a particle to be produced, so performance of the sensor unit is not reduced.

2. Description of the Prior Art

As mobile phones increasingly include photo functions, ready-made photo modules are often applied. These photo modules generally have simple structures. Please refer to FIG. 1. FIG. 1 is a diagram of a photo module 10 according to the related art. The photo module 10 consists of a lens 20 and a cover 30. A thread structure outside the lens 20 and the cover 30 has a screw hole. Another thread corresponding to the original thread is inside the screw hole. When the lens 20 is rotated in the direction of the arrow shown in FIG. 2, the lens 20 slowly lodges in the screw hole of the cover 30. In the cover 30, an optical sensor (not illustrated) is positioned below the screw hole, through rotating the lens 20 to adjust a relative distance between the lens 20 and the optical sensor. In this way a light beam can be correctly focused on the optical sensor. Please refer to FIG. 2. FIG. 2 is a cross-sectional view of the photo module 10 shown in FIG. 1. As mentioned above, the lens 20 and the cover 30 are combined by a thread structure. When the lens 20 is rotated, the lens 20 moves along the thread direction, resulting in the lens 20 being close to or far away from the optical sensor 40. Unfortunately, due to the thread structure, when the lens 20 is rotated, surface friction between the lens 20 and the cover 30 produces particles 50a-50c. The optical sensor 40 lies under the lens 20, so the particles will fall directly onto the optical sensor 40 (such as the particle 50c shown in FIG. 2), influencing the imaging function of the optical sensor 40. The performance of the photo module 10 is greatly reduced.

### SUMMARY OF THE INVENTION

It is therefore one of the objectives of the claimed invention to provide a photo module that separately positions the focus-adjusting module and the lens module. When the focus-adjusting module drives the lens module to move, no particle will be produced due to friction between the lens module and the cover.

According to an embodiment of the present invention, a photo module is disclosed. The photo module includes a sensor unit for detecting and transforming a light beam into an image; a lens module includes a lens set for receiving and focusing the light beam, and a focus-adjusting module coupled to the lens set, for controlling the lens set to move without rotating, and adjust the relative distance between the lens set and the sensor unit, thereby forcing the lens module to focus the light beam on the sensor unit.

According to another embodiment of the present invention, a photo module is further disclosed. The photo module includes a sensor unit for detecting and transforming a light beam into an image; and a lens module for receiving and focusing the light beam. The lens module includes a lens set and a holder wherein the lens set is applied to receive and focus the light beam and the holder is applied to protect the sensor unit. A focus-adjusting module, coupled to an outside part of the holder, is utilized for controlling the relative distance between the lens set and the sensor unit, thereby forcing the lens module to focus the light beam on the sensor unit.

The photo module disclosed in the claimed invention separately positions the focus-adjusting module and the lens module such that when the focus-adjusting module is rotated to move the lens set, particles produced when rotating the focus-adjusting module will not fall on the sensor unit as the focus-adjusting module is not positioned over the sensor unit. Additionally, because the lens set does not rotate relative to the cover when the lens set moves, the photo module disclosed in the present invention does not have to consider the particle issue, so the imaging function of the sensor unit is capable of ignoring the particles and maintaining a high performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a photo module according to the related art.

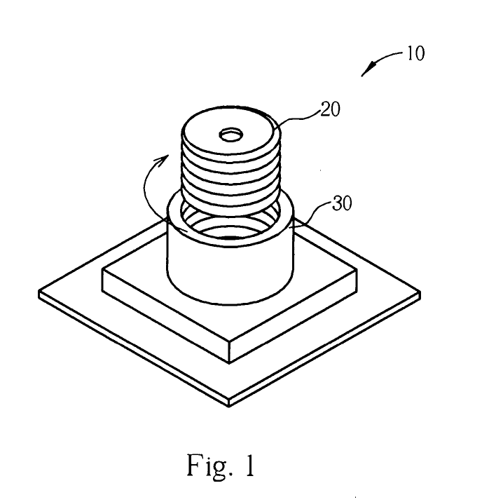

FIG. 2 is a cross-sectional view of the photo module shown in FIG. 1.

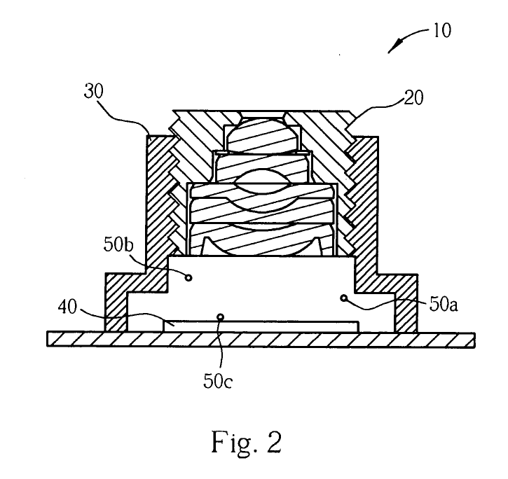

FIG. 3 is a diagram of a photo module according to an embodiment of the present invention.

FIG. 4 is a diagram of elements that make up the photo module shown in FIG. 3.

FIG. 5 is a diagram illustrating how to adjust the position of a lens set in the photo module shown in FIG. 3.

FIG. 6 is a cross-sectional view of the photo module shown in FIG. 3.

### DETAILED DESCRIPTION

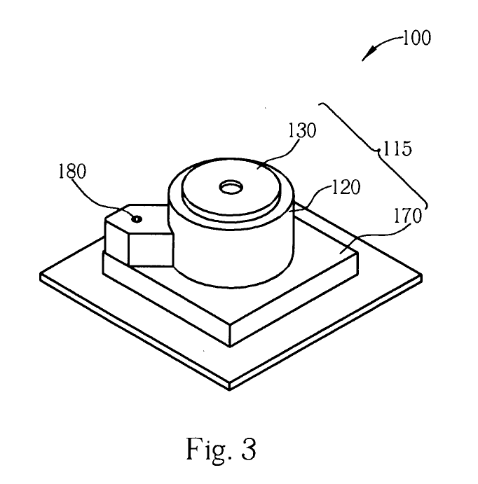

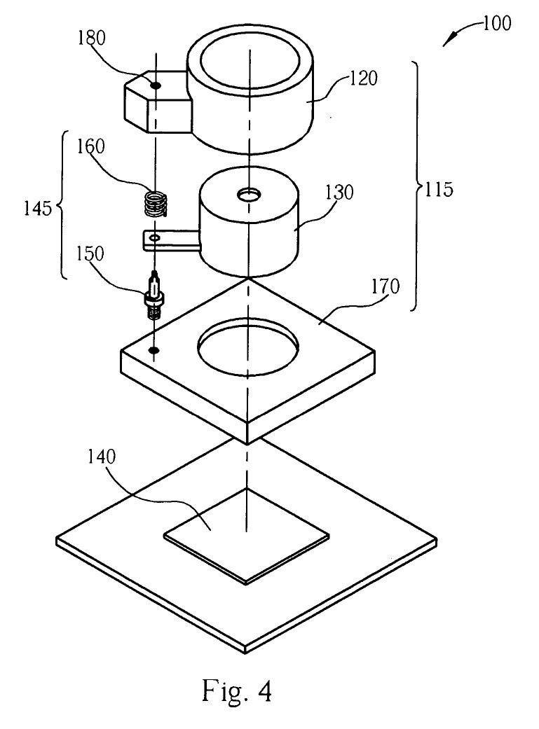

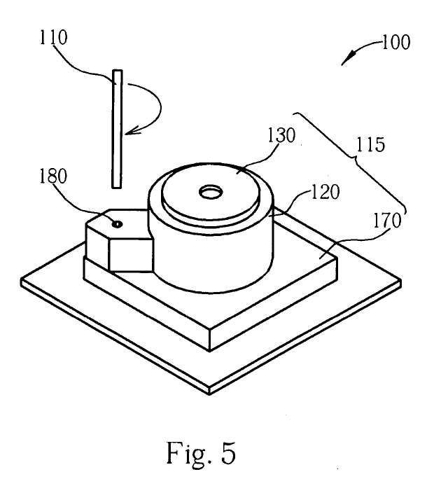

Please refer to FIG. 3, FIG. 4 and FIG. 5. FIG. 3 is a diagram of the photo module 100 according to an embodiment of the present invention, and FIG. 4 is a diagram of elements that make up the photo module 100 shown in FIG. 3. The photo module 100 disclosed in the present invention can be applied in various devices requiring photo function, such as a mobile phone including a photo function. The photo module 100 includes a lens module 115, a sensor unit 140 and a focus-adjusting module 145, wherein the lens module 115 includes a top cover 120, a lens set 130, and a holder 170. There is an opening 180 on the top cover 120, and the position of the opening 180 corresponds to the position of the focus-adjusting module 145. The sensor unit 140 is directly under the lens set 130. Furthermore, in the embodiment, the focus-adjusting module 145 includes a guide pin 150 and a spring 160. If it is desired to move the lens set 130 in order to adjust the relative distance between the lens set 130 and the sensor unit 140 so that the lens set 130 focuses a light beam on the sensor unit 140, a focus-adjusting tool (such as a metal rod) can be inserted into the opening 180 shown in FIG. 3 and rotated to control the focus-adjusting module 145 to drive the lens set 130 to move. Please refer to FIG. 5. FIG. 5 is a diagram illustrating how to adjust the position of the lens set 130 in the photo module 100 shown in FIG. 3 through utilizing the focus-adjusting tool 110. For example, when the focus-adjusting tool 110 is rotated in the direction of the arrow, the lens set 130 moves close to the sensor unit 140; however, when the focus-adjusting tool 110 is rotated in the direction away from the arrow, the lens set 130 moves far away from the sensor unit 140. By applying the focus-adjusting tool 110 and the focus-adjusting module 145, the relative distance between the lens set 130 and the sensor unit 140 is adjusted.

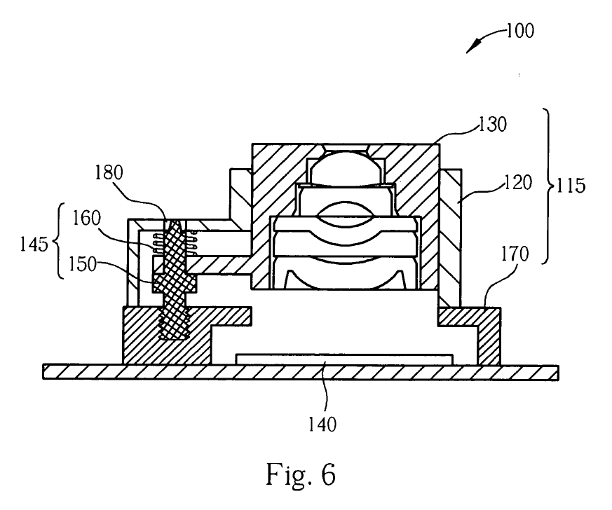

In order to clearly discuss the focus mechanism of the photo module 100, please refer to FIG. 6. FIG. 6 is a cross-sectional view of the photo module 100 shown in FIG. 3. The photo module 100 substantially includes three parts: the first part is the sensor unit 140, for detecting and transforming a light beam into an image; the second part is the lens set 130, for receiving and focusing the light beam; and the third part is the focus-adjusting module 145, for adjusting the relative distance between the lens set 130 and the sensor unit 140, thereby forcing the lens set 130 to focus the light beam on the sensor unit 140. The focus-adjusting module 145 is coupled to the lens set 130 and is substantially constructed from a rotatable device such as a guide pin 150 having a thread on one end. Furthermore, for precisely controlling the position of the lens set 130 by the focus-adjusting module 145, the focus-adjusting module 145 includes an elastic device such as a spring 160. One end of the spring 160 is fixed on the top cover 120 and the other end touches an outstanding arm of the lens set 130. The elastic force of the spring 160 pushes the lens set 130 to closely contact the guide pin 150 under the lens set 130. As a result, when the guide pin 150 moves upwards or downwards with respect to the holder 170, the lens set 130 also moves upwards or downwards with respect to the sensor unit 140. Additionally, the threaded end of the guide pin 150 connects a screw hole with a thread corresponding to the threaded end, so the guide pin 150 can move upwards or downwards with respect to the holder 170 through rotating the guide pin 150. The focus-adjusting tool 110 shown in FIG. 5 is connected to the guide pin 150 through the opening 180, therefore, rotation of the focus-adjusting tool 110 drives the guide pin 150 to rotate, and consequently drives the lens set 130 to move upwards or downwards with respect to the sensor unit 140 in order to adjust a focal length. Because the holder 170 is positioned between the guide pin 150 and the sensor unit 140, the holder 170 isolates particles produced by rotation friction of the guide pin 150 and the holder 170 such that the particles will not fall on the sensor unit 140. Although the lens set 130 is above the sensor unit 140, motion of the lens set 130 does not utilize the thread to rotate relative to the top cover 120, and therefore, in an ideal situation, no particle is produced when the lens set 130 moves. In a non-ideal situation the falling particles are far less than the ones produced in the prior art.

In the embodiment, the operation of the spring 160 provides an elastic force to make the lens set 130 closely contact the guide pin 150 positioned under the lens set 130. That is, the spring 160 can be replaced by another elastic device having the same function, and the spring 160 is placed between the top cover 120 and the outstanding arm of the lens set 130. For example, the spring 160 can be positioned between the holder 170 and the outstanding arm of the lens set 130 for providing an elastic force to pull the lens set 130 to closely connect with the guide pin 150 under the lens set 130. Another method directly fixes the outstanding arm of the lens set 130 on the guide pin 150; for example, by assembling two metal sheets on the guide pin 150 and positioning the outstanding arm of the lens set 130 between two metal sheets to fix the lens set 130. In this case, motion of the guide pin 150 drives the lens set 130 to move with the guide pin 150.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A photo module, comprising:
a sensor unit for detecting and transforming a light beam into an image;
a lens module that comprises a lens set for receiving and focusing the light beam; and
a focus-adjusting module coupled to the lens set, for controlling a relative distance between the lens set and the sensor unit, thereby forcing the lens module to focus the light beam on the sensor unit.

2. The photo module of claim 1 wherein the photo module further comprises a holder for protecting the sensor unit; wherein the focus-adjusting module is coupled to the holder and the lens set, and the focus-adjusting module drives the lens set to move towards the holder.

3. The photo module of claim 2 wherein the focus-adjusting module is a rotatable device for rotating relative to the holder in order to move towards the holder.

4. The photo module of claim 3 wherein the holder comprises a screw hole corresponding to a thread on one end of the focus-adjusting module, and the end of the focus-adjusting module is screwed into the screw hole on the holder.

5. The photo module of claim 2 wherein the lens module further comprises a top cover positioned on the holder for protecting the lens set, and the focus-adjusting module comprises:
an elastic device, having one end coupled to the lens set and the other end coupled to the top cover, for providing elastic force to make the lens set and the focus-adjusting module move together.

6. The photo module of claim 5 wherein the elastic device is a spring.

7. The photo module of claim 2 wherein the lens module further comprises a top cover positioned on the holder for protecting the lens set, and the focus-adjusting module comprises:
an elastic device, one end coupled to the lens set and the other end coupled to the holder, for providing an elastic force to make the lens set and the focus-adjusting module move together.

8. The photo module of claim 7 wherein the elastic device is a spring.

9. The photo module of claim 2 wherein the sensor unit is positioned inside the holder and the focus-adjusting module is coupled outside the holder.

10. The photo module of claim 1 being applied in a mobile phone.
